(19) United States
(12) Patent Application Publication
(10) Pub. No.: US 2007/0253315 A1
(43) Pub. Date: Nov. 1, 2007

(54) Brushless Motor and Disc Driving Apparatus

(75) Inventor: Masahiro Yamada, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: NIDEC CORPORATION, Kyoto (JP)

(21) Appl. No.: 11/380,664

(22) Filed: Apr. 28, 2006

(51) Int. Cl. G11B 23/00

(52) U.S. Cl. 369/266

(57) ABSTRACT

A position detecting means fixed to a first circuit board has a resin table integrally forming a current-carrying pin, a second circuit board mounted on an upper surface of the resin table, and a position detecting element mounted on the second circuit board, protrudes the current-carrying pin to an upper surface and a side surface of the resin table by forming the current current-carrying pin in an approximately L shape, and electrically conducts the first circuit board and the second circuit board.

### BACKGROUND OF THE INVENTION

1. Technical Field

The present invention relates to a brushless motor used for driving a discoid disc such as a CD, a DVD or the like, and a disc driving apparatus mounting the brushless motor thereon.

2. Description of the Related Art

In recent years, in the brushless motor driving the discoid disc, there is a case that a discoid disc is rotated at a low speed equal to or less than 1000 rpm for applying various drawing prints on a label surface corresponding to an opposite surface to a recording surface carrying out a recording and a reproducing of the discoid disc, by using a laser type pickup. In the low-speed rotation control mentioned above, a position detecting structure using an optical element is mounted.

A description will be given of a fixing structure of a conventional position detecting structure 4 with reference to FIG. 11. A dotted circle in FIG. 11 shows an enlarged view of the position detecting means 4.

A mounting plate 2 is fixed to a lower side in an axial direction of a rotation portion 1 rotating around a rotation axis. Further, a flexible circuit board 3 (hereinafter, refer simply to as FPC) is fixed to an upper surface of the mounting plate 2. The position detecting structure 4 is constituted by an optical element 5 mounted on an upper surface of the FPC 3, and a resin table 7 fixed to an upper surface of the mounting plate 2 and determining a distance between the discoid disc 6 and the optical element 5. Further, a position to which the optical element 5 is mounted in the FPC 3 is fixed to an upper surface of the resin table 7. Accordingly, the optical element 5 is positioned in an axial direction and a diametrical direction.

However, since the fixing between the FPC 3 and the upper surface of the resin table 7 is achieved by an adhesive material, there is a possibility that the FPC 2 peels. Accordingly, the optical element 5 is inclined, and is moved in a diametrical direction and a peripheral direction. As a result, there is a possibility that an accurate drawing can not be applied on the label surface of the discoid disc 6.

Further, the FPC 3 and the resin table 7 are positioned in the peripheral direction and the diametrical direction by a projection 7a provided in an upper surface of the resin table 7 and a hole 3a formed in the FPC 3 and engaging with the projection 7a. However, since the FPC 3 is thin and the FPC3 is deflected, a working efficiency of an engagement between the projection 7a and the hole 3a is deteriorated. Therefore, there is generated a problem that a production efficiency is lowered.

### BRIEF SUMMARY OF THE INVENTION

In accordance with the present invention, there can be provided a brushless motor to which a position detecting structure can be easily and accurately attached, and a disc driving apparatus to which the brushless motor is mounted.

A brushless motor in accordance with the present invention is constituted by a rotation portion including a turntable and a rotor magnet and a fixed portion including a stator faces to the rotor magnet. The fixed portion including a mounting plate which is arranged in an axially lower side of said stator, a first circuit board which is arranged on an axially upper surface of said mounting plate, and a position detecting structure which is conducted to the first circuit board. In this case, it is desirable that the position detecting structure is structured such as to optically detect.

The position detecting structure in accordance with the present invention is constituted by an insulating resin table integrally forming a current-carrying pin, a second circuit board mounted on an upper surface in axial direction of the insulating resin table, and a position detecting element mounted on the second circuit board. Further, the current-carrying pin is formed in an approximately L shape protruding from an upper surface and a side surface in an axial direction of the insulating resin table. It is possible to easily conduct the first circuit board and the second circuit board by the current-carrying pin in accordance with a conducting work.

Further, the insulating resin table in the position detecting structure in accordance with the present invention has an upper positioning projection executing a positioning with the second circuit board and a lower positioning projection executing a positioning with the first circuit board. Further, a positioning concave portion is formed in surfaces of the second circuit board and the first circuit board corresponding to the upper positioning projection and the lower positioning projection. The positioning concave portions prevent a mounting fault caused by a forming error of the insulating resin table and a forming error of the first circuit board and the second circuit board, by making a dimension in a diametrical direction of any one of them slightly larger than the positioning projection.

Further, the first circuit board is positioned in the peripheral direction and the diametrical direction by printing a positioning mark simulating an outer shape of the position detecting structure at a position where the position detecting structure is arranged. In the case of printing the positioning mark, it is unnecessary to form the lower positioning projection in the insulating resin table and to form the positioning concave portion in the first circuit board.

### BRIEF DESCRIPTION OF THE SEVERAL VIEWS OF THE DRAWINGS

Referring now to the attached drawings which form a part of this original disclosure:

FIG. 1 is a schematic cross sectional view obtained by cutting a brushless motor in accordance with the present invention in an axial direction;

FIG. 2 is a top elevational view of the brushless motor in accordance with the present invention;

FIG. 3 is a side elevational view of the brushless motor in accordance with the present invention;

FIG. 4 is a part of a plan view showing a relation between a position detecting means in accordance with the present invention and a discoid disc;

FIG. 5 is a view showing a resin table in accordance with the present invention;

FIG. 6 is a top elevational view showing a second circuit board in accordance with the present invention;

FIG. 7 is a side elevational view showing a current-carrying pin in accordance with the present invention;

FIG. 8 is a top elevational view showing a position detecting means in accordance with the present invention, and corresponds to an enlarged view of FIG. 2;

FIG. 9 is a side elevational view showing the other embodiment of the position detecting means in accordance with the present invention;

FIG. 10 is a side elevational view showing the other embodiment of the position detecting means in accordance with the present invention; and

FIG. 11 is a side elevational view showing a conventional brushless motor.

### DETAILED DESCRIPTION OF THE INVENTION

Entire Structure of Brushless Motor

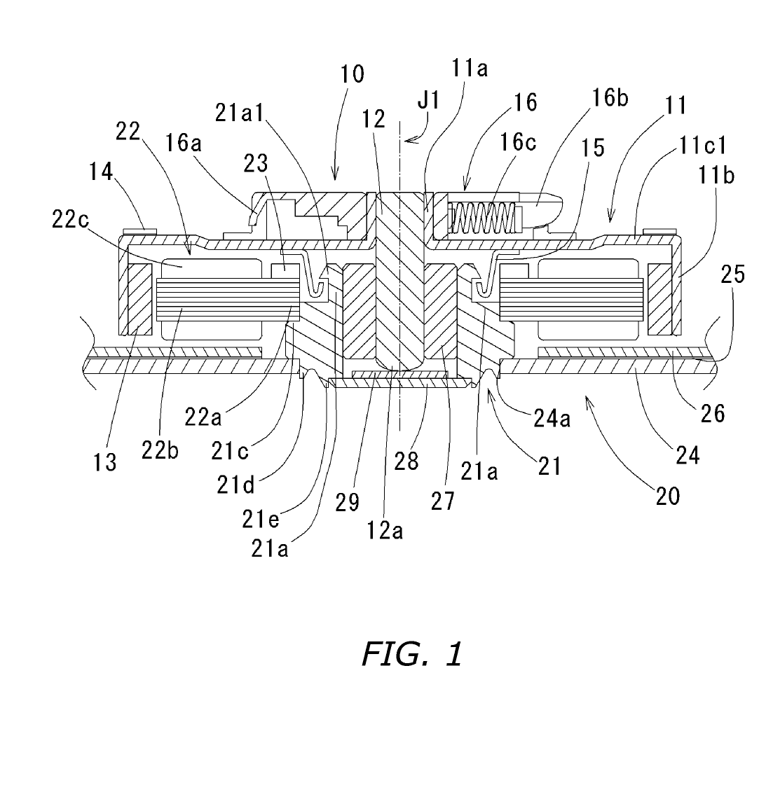

A description will be given of an aspect of an embodiment of a brushless motor in accordance with the present invention with reference to FIG. 1. FIG. 1 is a schematic cross sectional view obtained by cutting the brushless motor in an axial direction.

Referring to FIG. 1, the brushless motor is constituted by a rotation portion 10 rotating around a periphery of a rotation axis J1, and having a rotor magnet mentioned below rotating a discoid disc (not shown in FIG. 1), and a fixed portion 20 having a stator 22 mentioned below having a surface facing to the rotor magnet in a diametrical direction.

A description will be given first of the fixed portion 20.

A bush 21 formed of a metal material has an inner peripheral surface having a cylindrical shape. Further, a thin cylinder portion 21a is formed in an upper portion in an axial direction of the bush 21. In an outer peripheral side of a lower portion in an axial direction of the cylinder portion 21a, there is formed a diametrically extension portion 21b extending to an outer side in a diametrical direction in such a manner that a thickness becomes large. A stator mounting portion 21c mounting a stator 22 is formed in a further outer side in the diametrical direction of the diametrically extension portion 21b in such a manner as to form a step portion with respect to the diametrically extension portion 21b. Further, an outer peripheral caulking portion 21d and an inner peripheral caulking portion 21e are respectively formed in an outer peripheral side and an inner peripheral side of a lower portion in an axial direction of the bush 21.

The stator 22 is structured by a circular ring-shaped core back portion 22a brought into contact with the stator mounting portion 21c so as to be fixed, a teeth portion 22b radially extending from the core back portion 22a, and a coil 22c wound around the teeth portion 22b via an insulating member or an insulating coating (not shown). Further, a circular ring-shaped preload magnet 23 is fixed to an upper surface in an axial direction of the core back portion 22a. The preload magnet 23 and the lower surface in the axial direction of a cover portion 11c of a rotor holder 11 mentioned below are attracted with each other by a magnetic force, whereby a position in the axial direction of the rotation portion 10 is stabilized.

A mounting plate 24 made of a metal plate material has a circular opening hole 24a, and plastically deforming the outer peripheral caulking portion 21d to an outer peripheral side so as to fix in accordance with a caulking by bringing an inner peripheral surface and a peripheral edge of the opening hole 24a into contact with lower end surfaces of the outer peripheral caulking portion 21d and the stator mounting portion 21c of the bush 21.

A first circuit board 26 is fixed to an upper surface in an axial direction of the mounting plate 24 via an insulating coating 25 (or an insulating member 25). A circuit is formed in both surfaces in the axial direction of the first circuit board 26. Accordingly, the insulating coating 25 (or the insulating member 25) is interposed for preventing a short circuit between the mounting plate 24 and the first circuit board 26.

A sleeve 27 in which a sintered body impregnated with an oil is formed in an approximately cylindrical shape is fixed to an inner peripheral surface of the bush 21. Further, a disc-shaped plate 28 putting a lid on the inner peripheral surface of the bush 21 is fixed to the inner peripheral caulking portion 21e of the bush 21 by plastically deforming the inner peripheral caulking portion 21e to an inner peripheral side in accordance with a caulking. An approximately disc-shaped thrust plate 29 formed by a resin material having a good sliding performance is arranged in an upper surface in an axial direction of the plate 28.

Next, a description will be given of the rotation portion 10.

The rotor holder 11 obtained by forming a metal plate material having a magnetism in an approximately cylindrical shape in accordance with a plastic forming is arranged approximately coaxially with the rotation axis J1. An inner cylinder portion 11a and an outer cylinder portion 11b are formed in the rotor holder 11. Further, a shaft 12 rotating as the rotation axis J1 is fixed to an inner peripheral surface of the inner cylinder portion 11a in accordance with a press fit or an adhesion or a combination between the press fit and the adhesion. The shaft 12 is inserted to an inner peripheral surface of the sleeve 21. Further, a lower end surface 12a of the shaft 12 is formed in an approximately semispherical shape, and the lower end surface 12a and the thrust plate 29 slide. Accordingly, the shaft 12 is supported by the sleeve 27 and the thrust plate 29 so as to be rotatable in the diametrical direction and the axial direction.

A rotor magnet 13 having an approximately circular ring shape is fixed to an inner peripheral surface of the outer cylinder portion 11b of the rotor holder 11 in accordance with an adhesion. Further, an inner peripheral surface of the rotor magnet 13 and an outer peripheral surface of the teeth portion 22b of the stator 22 face to each other via a gap in a diametrical direction.

There is formed a cover portion 11c coupling the inner peripheral cylinder portion 11a and the outer cylinder portion 11b of the rotor holder 11. Further, a rubber mounting surface 11c1 annularly protruding to an upper side in an axial direction is formed in an outer side in a radial direction of the cover portion 11c. Further, a rubber 14 having a circular ring shape and mounting the discoid disc via an adhesive material is fixed to an upper surface in the axial direction of the rubber mounting surface 11c1. Further, a hook-shaped come-off prevention member 15 is fixed to a lower surface in an axial direction of the cover portion 11c in accordance with a welding. Further, an engagement portion 21a1 extending to an outer side in a diametrical direction is formed in an outer peripheral surface of an upper portion in an axial direction of the cylinder portion 21a of the bush 21. The engagement portion 21a1 and the come-off prevention member 15 form a come-off prevention mechanism by being arranged so as to be overlapped in a diametrical direction.

A turntable 16 having an approximately closed-end cylindrical shape is fixed to an outer peripheral surface of the inner cylinder portion 11a of the rotor holder 11 in accordance with a press fit or an adhesion or a combination between the press fit and the adhesion. The turntable 16 executes an aligning between the rotation center of the discoid disc and the rotation axis J1 and a holding of the discoid disc. Further, a lower surface of the turntable 16 is brought into contact with the upper surface of the cover portion 11c of the rotor holder 11 so as to determine the position in the axial direction.

The turntable 16 is constituted by an aligning hook 16a brought into contact with an inner peripheral surface of an opening hole of the discoid disc and aligning the rotation center of the discoid disc and the rotation axis J1, a holding member 16b holding the inner peripheral surface of the discoid disc and the inner peripheral edge of the upper surface in the axial direction by protruding to the outer side in the diametrical direction, and a coil spring 16c energizing the holding member 16b to an outer side in the diametrical direction.

An electric current is applied to the coil 22c of the stator 22 from an external power source (not shown), whereby a magnetic field is generated around the stator 22. Further, the rotation portion 10 is rotationally driven on the basis of a mutual action between the magnetic field and the rotor magnet 13.

Position in Diametrical Direction and Axial Direction of Position Detecting Structure

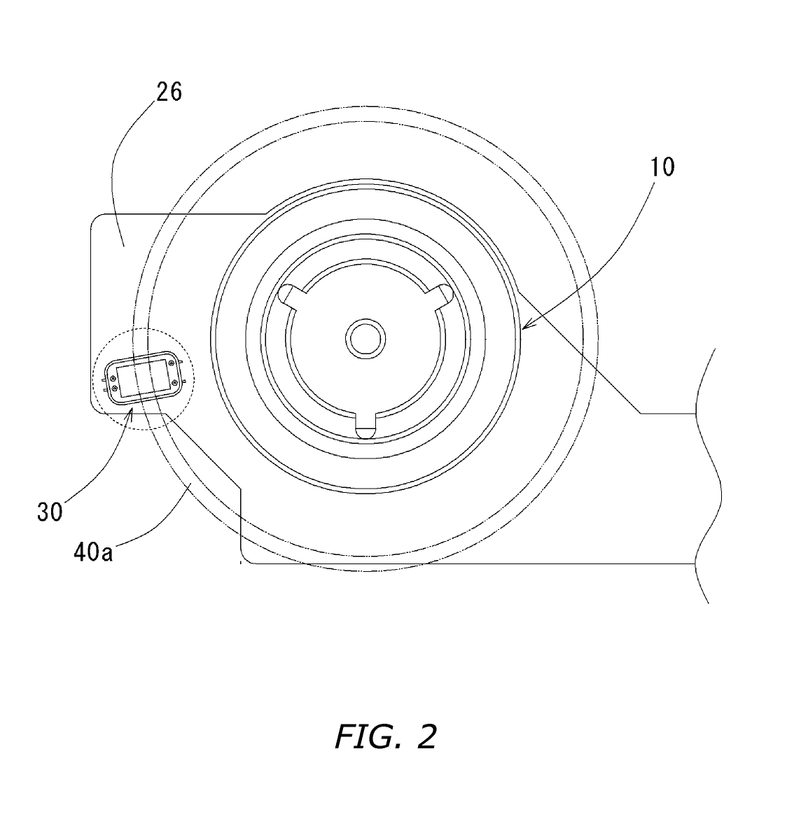

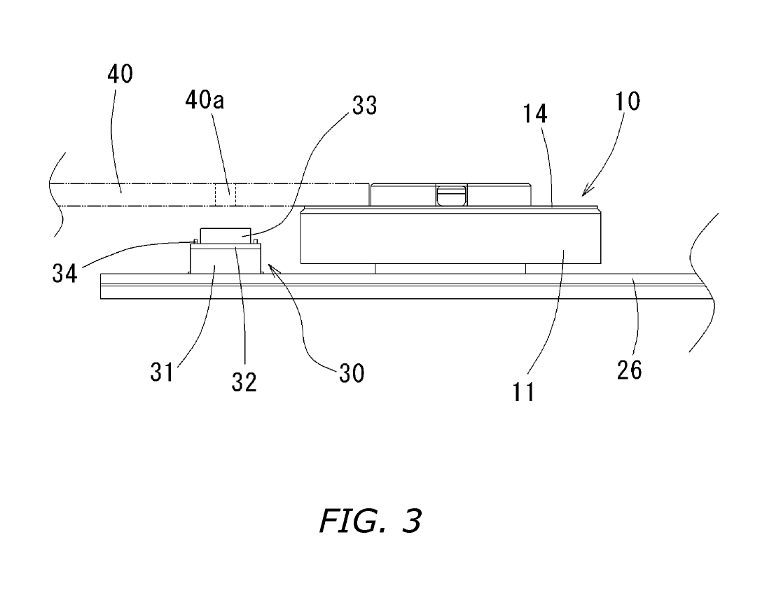

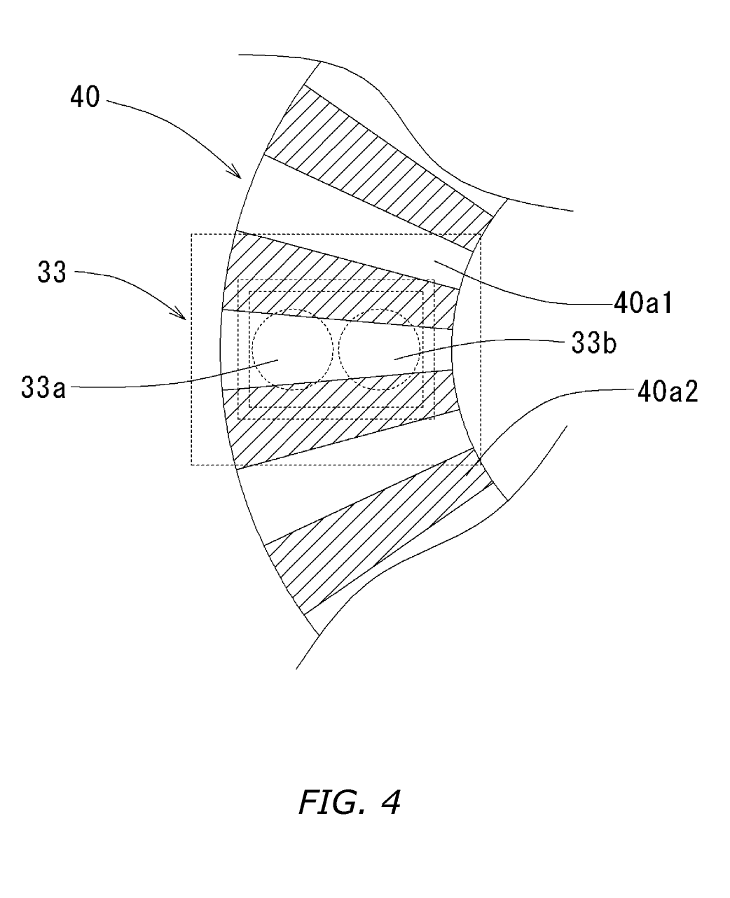

Next, a description will be given of a position in a diametrical direction and an axial direction of a position detecting structure with reference to FIGS. 2 to 4. FIG. 2 is a top elevational view of the brushless motor in accordance with the present invention, and FIG. 3 is a side elevational view of the brushless motor in accordance with the present invention. Further, FIG. 4 is a partial plan view showing a relation between a position detecting element and the discoid disc.

Referring to FIG. 3, a position detecting structure 30 is arranged near an outer side in the diametrical direction of the rotor holder 11 of the rotation portion 10 in the first circuit board 26.

The position detecting structure 30 is constituted by a insulating resin table 31 fixed to the upper surface in the axial direction of the first circuit board 26, a second circuit board 32 arranged in an upper surface in an axial direction of the insulating resin table 31, a position detecting element 33 mounted on an upper surface in an axial direction of the second circuit board 32, and a current-carrying pin 34 integrally formed in the insulating resin table 31 and electrically conducting the first circuit board 26 and the second circuit board 32. In this case, as the position detecting element 33, a photo sensor executing a light receiving and a light emitting is desirable. A detecting surface is positioned in an upper surface of the position detecting element 33. Further, the position detecting element 33 is arranged at a position which is slightly lower in an axial direction than an upper surface in the axial direction of the rubber 14. When a discoid disc 40 is mounted on the upper surface in the axial direction of the rubber 14, the detecting surface of the position detecting element 33 faces to the lower surface in the axial direction of the discoid disc via a slight gap (about 2 mm).

An annular pattern forming portion 40a is coaxially formed between a disc inner peripheral portion of the discoid disc 40 and a recording region in an outer peripheral side thereof. Further, the position detecting element 33 of the position detecting structure 30 faces to the pattern forming portion 40a.

Referring to FIG. 2, the position detecting structure 30 is arranged in a diametrical direction so as to include all the region of the pattern forming portion 40a.

Referring to FIG. 4, the pattern forming portion 40a of the discoid disc 40 is structured by alternately arranging a reflection pattern portion 40a1 and a non-reflection pattern portion 40a2 having a predetermined width in a peripheral direction. Further, the position detecting element 33 has a light emitting portion 33a emitting the light and a light receiving portion 33b receiving the light. The light emitted from the light emitting portion 33a of the position detecting element 33 is reflected by the reflection pattern portion 40a1 and is received by the light receiving portion 33b. On the other hand, since the light emitted from the light emitting portion 33a is absorbed in the non-reflection pattern portion 40a2, the light is not received by the light receiving portion 33b. Accordingly, it is possible to obtain a pulse signal in correspondence to a brightness pattern of the pattern forming portion 40a. The recording surface of the discoid disc 40 is formed in one surface in the axial direction of the discoid disc 40. Further, the pattern forming portion 40a is formed in a label surface corresponding to one surface in an opposite side in the axial direction to the recording surface in the discoid disc 40.

The brushless motor having the position detecting structure 30 mentioned above is arranged in an inner portion of the disc driving apparatus, and in the inner portion of the apparatus, a laser type pickup (not shown) accessing the recording surface of the discoid disc 40 is provided in the mounting plate 24 side with respect to the discoid disc 40 mounted on the rubber 14 in the turntable 16 of the rotation portion 10 so as to be movable in the diametrical direction of the discoid disc 40.

Further, when mounting on the turntable 16 and the rubber 14 in a state of directing the label surface of the discoid disc 40 to the mounting plate 24 side, the position detecting element 33 optically executes the position detection with respect to the pattern forming portion 40a formed on the label surface. A low-speed rotation control of the rotation portion 10 is executed on the basis of the position detection signal.

Detailed Structure of Position Detecting Means

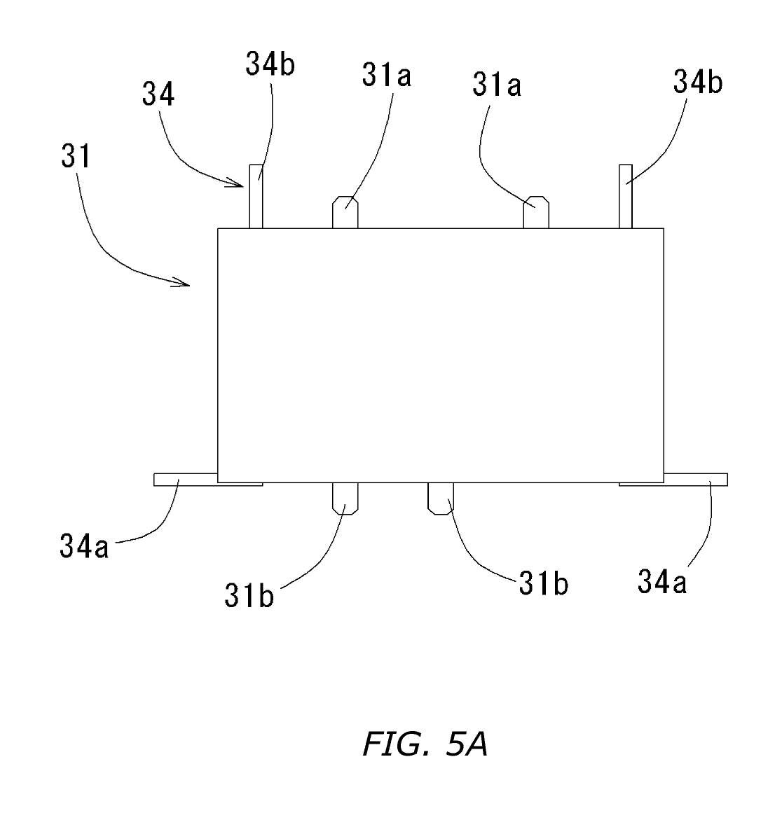

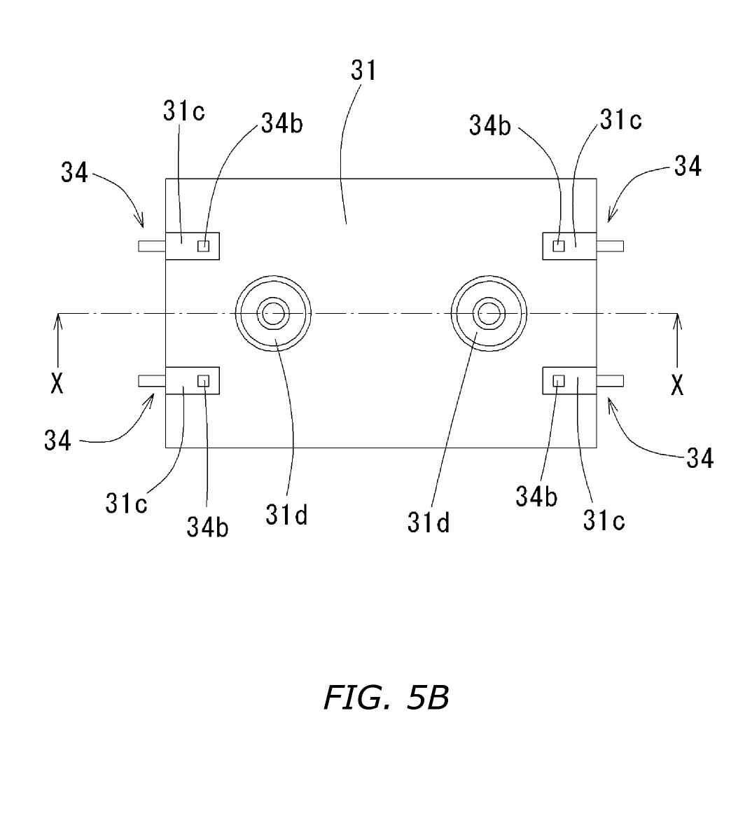

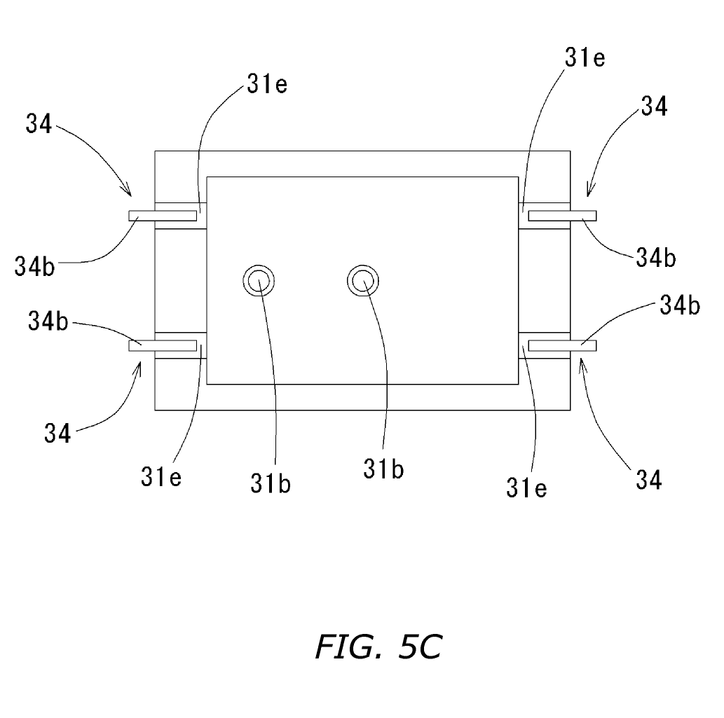

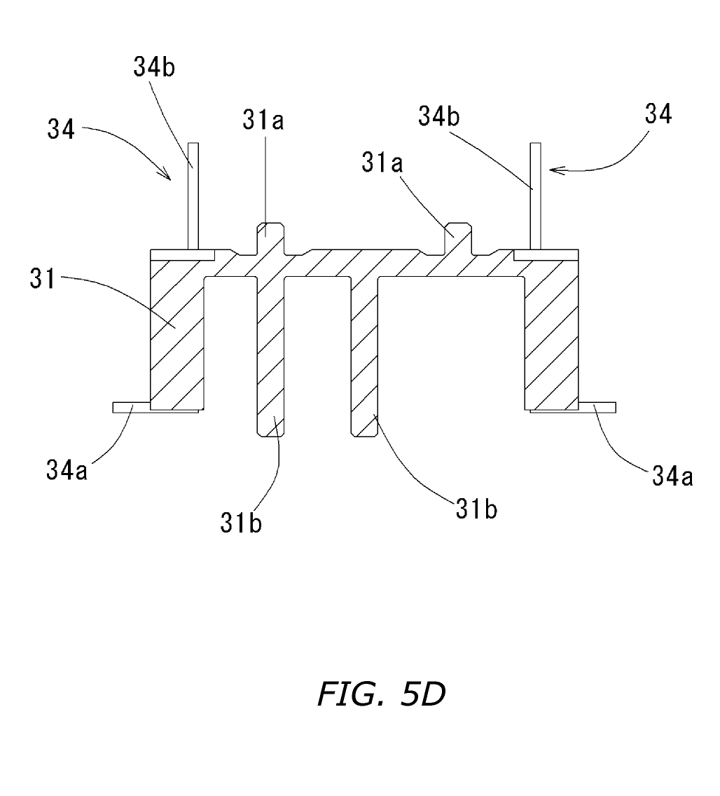

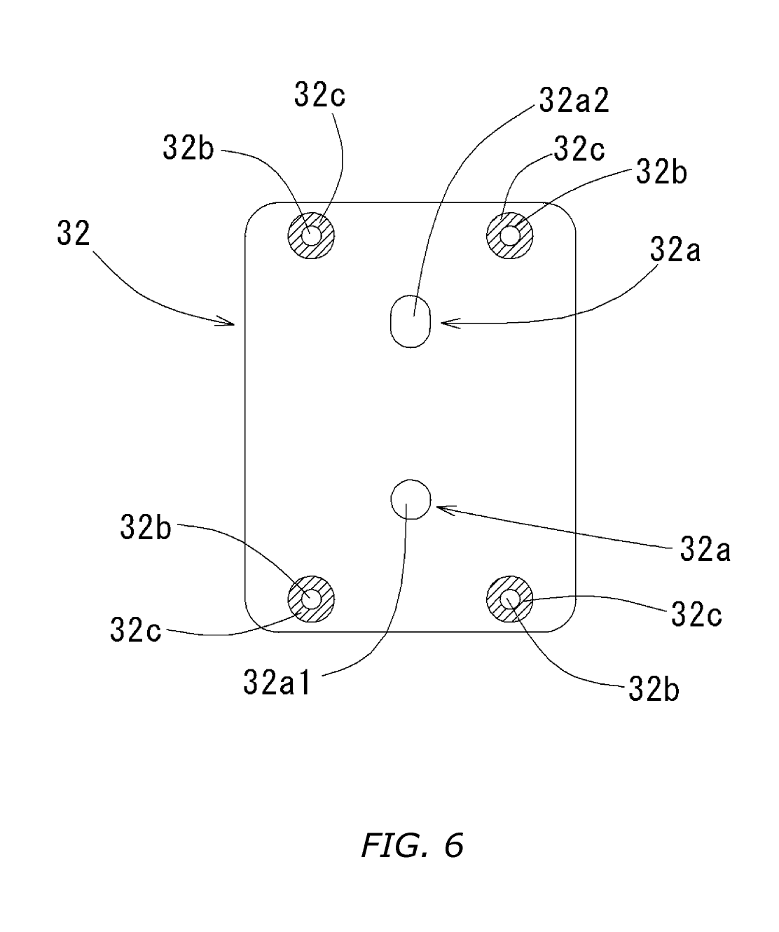

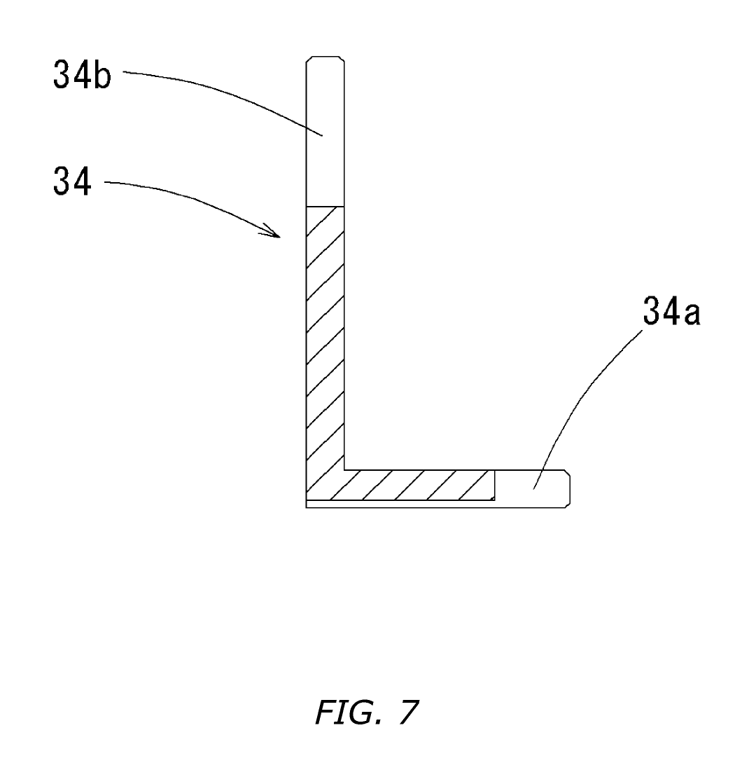

Next, a description will be given of each of parts structuring the position detecting structure 30 with reference to FIGS. 5 to 7. FIG. 5 shows the insulating resin table 31, in which FIG. 5A is a side elevational view of the insulating resin table 31, FIG. 5B is a top elevational view of the insulating resin table 31, FIG. 5C is a bottom elevational view of the insulating resin table 31, and FIG. 5D is a schematic cross sectional view in a direction X-X in FIG. 5B. FIG. 6 is a top elevational view showing a second circuit board 32. FIG. 7 is a view showing the current-carrying pin 34.

Referring to FIG. 5A, both ends of the current-carrying pin 34 protrude respectively to an upper surface in an axial direction and a side surface in a diametrical direction of the insulating resin table 31. In this case, a side end portion 34a of the current-carrying pin 34 protruding to the side surface in the diametrical direction protrudes to a lower side in the axial direction slightly from the lower surface in the axial direction of the insulating resin table 31. Accordingly, it is possible to prevent a gap from being generated between the side surface end portion 34a of the current-carrying pin 23 and the first circuit board 26 due to a slight error of the formation of the insulating resin table 31. As a result, it is possible to achieve a secure electric conduction between the current-carrying pin 34 and the first circuit board 26. Further, in the upper surface in the axial direction of the insulating resin table 31, two upper side positioning projections 31a determining the position in the diametrical direction and the peripheral direction of the second circuit board 32 are formed apart from each other in the diametrical direction at a time when the position detecting structure 30 is attached to the first circuit board 26. Further, in the lower surface in the axial direction of the insulating resin table 31, there is formed a lower side positioning projection 31b determining the position in the diametrical direction and the peripheral direction with the first circuit board 26.

Referring to FIG. 5B, four current-carrying pins 34 are integrally formed with the insulating resin table 31. Further, an upper surface concave portion 31c depressed to a lower side in the axial direction rather than an upper side in the axial direction of the insulating resin table 31 is formed around an upper surface end portion 34b of the current-carrying pin 34 (refer to FIG. 5D). Accordingly, it is possible to absorb an R portion formed in a coupling portion between the upper end portion 34b of the current-carrying pin 34 and the upper surface in the axial direction of the insulating resin table 31 by the upper surface concave portion 31c. In this case, if the R portion is formed in the upper end surface of the insulating resin table 31 on which the second circuit board 32 is mounted, there is a possibility that the second circuit board 32 is inclined by the R portion. As a result, the position detecting element 33 mounted on the second circuit board 32 is inclined, and there is a possibility that a position detection error is generated. However, since the R portion is not formed in the upper end surface of the insulating resin table 31 by forming the upper surface concave portion 31c, it is possible to horizontally arrange the second circuit board 32 without inclining. Further, an annular concave portion 31d is formed in the coupling portion between the upper positioning projection 31a and the upper surface in the axial direction of the insulating resin table 31 (refer to FIG. 5D). Accordingly, in the same manner as the upper surface concave portion 31c, it is possible to absorb the R portion formed in the coupling portion between the upper positioning projection 31a and the upper surface in the axial direction of the insulating resin table 31 by the annular concave portion 31d. Therefore, it is possible to horizontally mount the second circuit board 32 in the upper end surface of the insulating resin table 31.

Referring to FIG. 5C, a concave portion is formed in the center of the lower surface side in the axial direction of the insulating resin table 31. In other words, the insulating resin table 31 is formed in a concave shape in which a lower side in the axial direction surrounded by the peripheral wall is open. Further, the current-carrying pin 34 is exposed to the lower end surface of the peripheral wall. Further, a lower surface concave portion 31e is formed in the periphery of the current-carrying pin 34. Further, the lower positioning projection 31b protrudes from the lower surface side in the axial direction in the upper surface in the axial direction of the insulating resin table 31 (refer to FIG. 5D).

Referring to FIG. 6, a positioning concave portion 32a corresponding to the upper positioning projection 31a of the insulating resin table 31 is formed in the second circuit board 32. In this case, the positioning concave portion 32a may be formed as a through hole penetrating in an axial direction. Further, a positioning concave portion 32a1 in an inner side in a diametrical direction in the positioning concave portion 32a has a shape which is engaged with the upper positioning projection 31a with no gap in the diametrical direction and the peripheral direction. Further, a positioning concave portion 32a2 in an outer side in the diametrical direction has a shape with no gap in the peripheral direction and with a slight gap with the second circuit board in the diametrical direction. Accordingly, it is possible to prevent a mounting fault due to a forming error in the diametrical direction of the upper positioning projection 31a and a forming error in the diametrical direction of the positioning concave portion 32a2, by the positioning concave portion 32a2. Further, the shape of the positioning concave portion 32a may be set such that the positioning concave portions 32a1 and 32a2 have the reverse shapes.

Further, an opening hole 32b is formed at a position corresponding to the upper surface end portion 34b of the current-carrying pin 34, in the second circuit board 32. Further, a land portion 32c to which an electric current can be applied is formed in the periphery in the upper surface side in the axial direction of the opening hole 32b. The current-carrying pin 34 and the second circuit board 32 can be made electrically conductive by inserting the upper surface end portion 34b of the current-carrying pin 34 to the opening hole 32b and thereafter putting a solder within the land portion 32c.

Referring to FIG. 7, the current-carrying pin 34 is formed in an approximately L shape. Further, a hatched portion in the drawing is accommodated in the insulating resin table 31. Further, both ends adjacent to the hatched portion respectively form a side surface end portion 34a and an upper surface end portion 34b.

Mounting Structure of Position Detecting Means to First Circuit Board

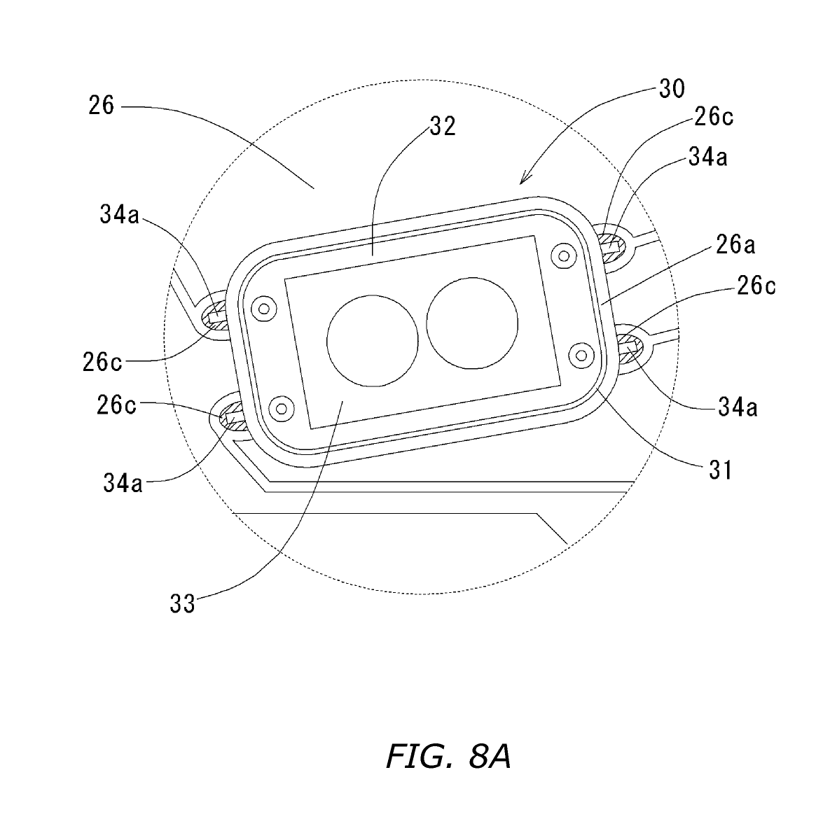

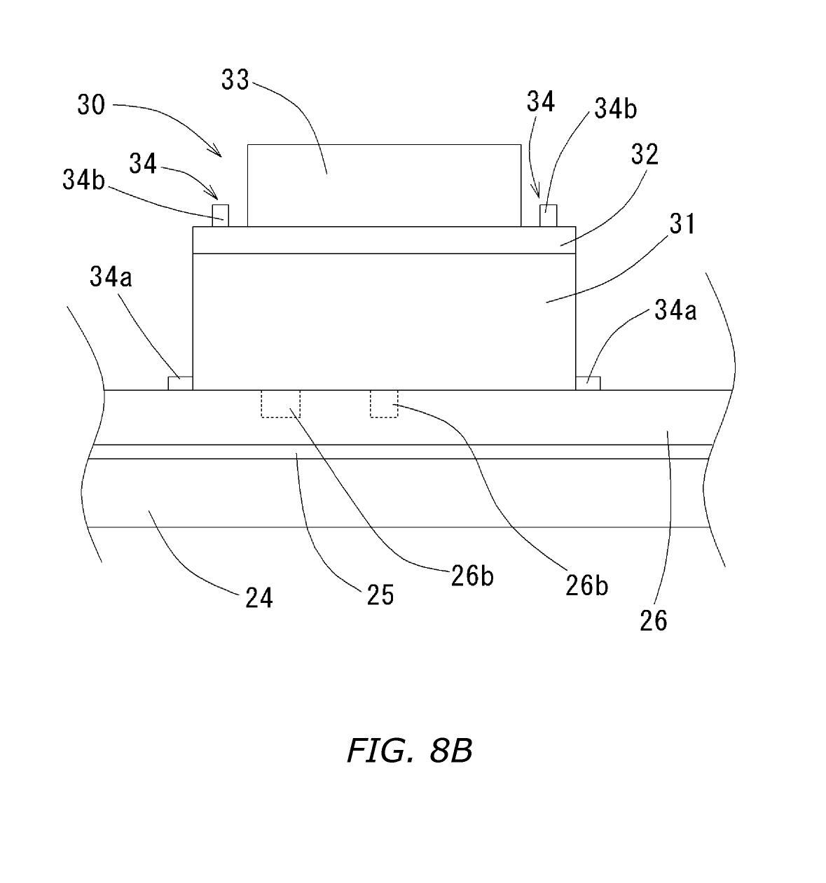

Next, a description will be given of a structure for attaching the position detecting structure 30 to the first circuit board 26 with reference to FIG. 8. FIG. 8A is an enlarged view near the position detecting structure 30 in FIG. 3. FIG. 8B is an enlarged view near the position detecting structure 30 in FIG. 2.

Referring to FIG. 8, an outer shape of the insulating resin table 31, that is, a position mark 26a simulating an outer shape of the position detecting structure 30 is printed on an upper surface in the axial direction of the first circuit board 26. Accordingly, it is possible to easily comprehend the position in the diametrical direction and the peripheral direction of the position detecting structure 30. Further, positioning concave portions 26b corresponding to the lower positioning projections 31b of the insulating resin table 31 are respectively formed in the first circuit board 26 (refer to FIG. 8B). The positioning concave portions 26b are formed in different shapes in the diametrical direction in the same manner as the positioning concave portions 32a formed in the second circuit board 32. Further, one of them is formed so as to be engaged with the lower positioning projection 31b with no gap in the peripheral direction and the diametrical direction, and the other is formed with no gap in the peripheral direction with the lower positioning projection 31b and with a slight gap in the diametrical direction. It is possible to absorb a forming error of the lower positioning projection 31b and a forming error of the positioning concave portion 26b of the first circuit board 26 due to the slight gap in the diametrical direction. Further, the positioning concave portion 26b may be formed as an opening hole.

A land portion 26c formed in the first circuit board 26 is formed in the side surface end portion 34a of the current-carrying pin 34 integrally formed with the insulating resin table 31. Further, the side surface end portion 34a is brought into contact with the land portion 26c. The current-carrying pin 34 and the first circuit board 26 can be conducted by additionally putting a solder on the land portion 26c. Accordingly, since the second circuit board 32 can be conducted with the upper surface end portion 34b of the current-carrying pin 34, and the first circuit board 26 can be conducted with the side surface end portion 34a, the first circuit board 26 and the second circuit board 32 can be conducted. Therefore, it is possible to precisely determine the positioning between the position detecting structure 30 and the first circuit board 26 only by soldering the position detecting structure 30 to the first circuit board 26, and it is additionally possible to easily conduct the position detecting structure 30 with the first circuit board 26. As a result, it is possible to improve a difficulty of positioning and a deterioration of a working efficiency such as the conventional FPC.

Other Embodiment of Position Detecting Means

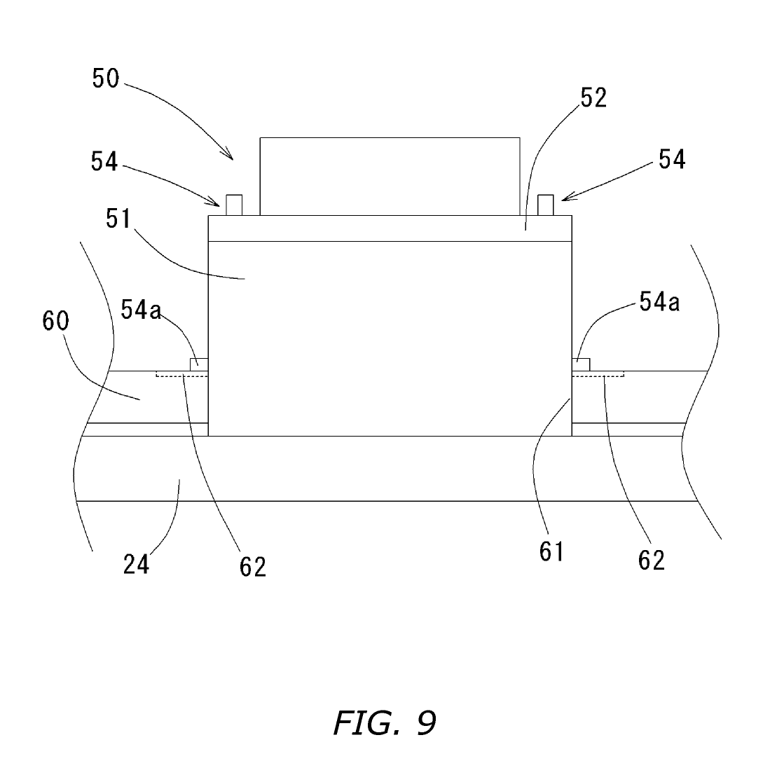

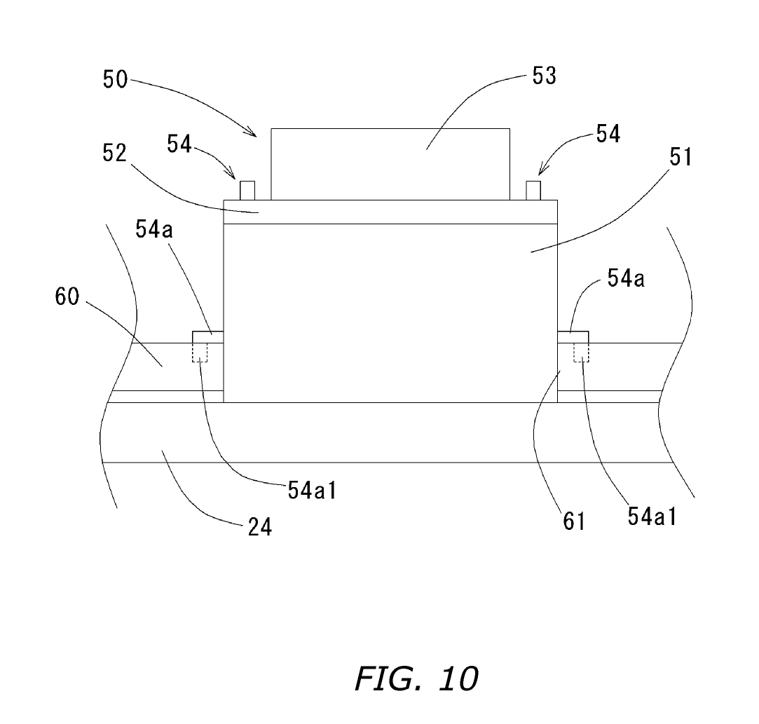

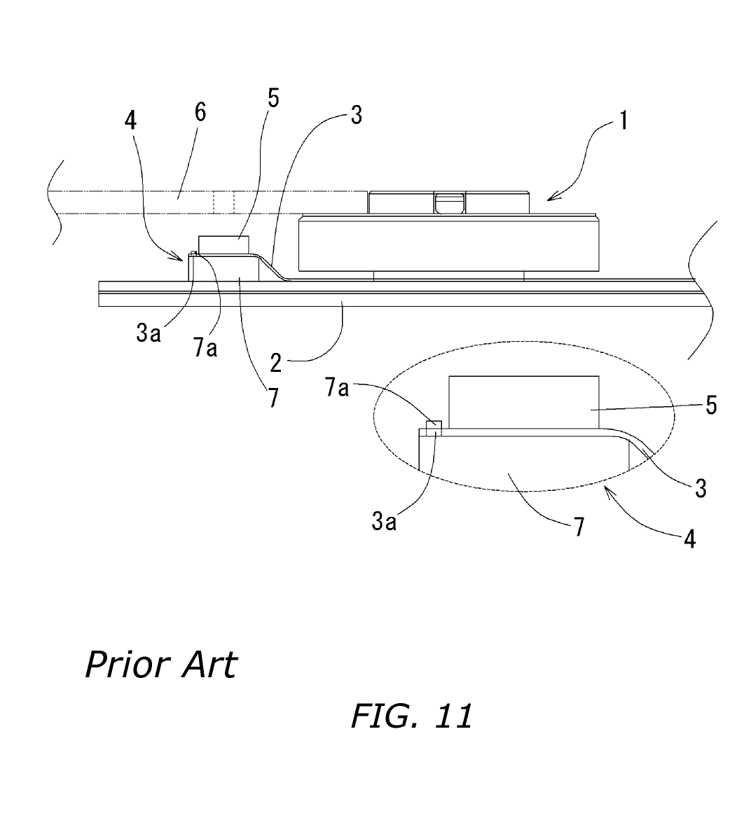

A description will be given of the other embodiment of the position detecting means with reference to FIGS. 9 and 10. The position detecting means in FIGS. 9 and 10 is constituted by a position detecting means 50. Further, the first circuit board is constituted by a first circuit board 60.

The position detecting means 50 is constituted by a resin table 51 integrally forming a current-carrying pin 54, a second circuit board 52 arranged in a top surface in an axial direction of the resin table 51, and a position detecting element 53 mounted on an upper surface in an axial direction of the second circuit board 52.

A side surface end portion 54a protruding from a side surface of the current-carrying pin 54 is formed so as to protrude to an upper side in an axial direction from a lower end surface in an axial direction of the resin table 51. A height of the side surface end portion 54a from the lower end surface in the axial direction of the resin table 51 is formed so as to coincide with a thickness in an axial direction of the first circuit board 60.

Further, an opening hole 61 having the same shape as an outer shape of the position detecting means 50 is formed in the first circuit board 60. Further, the position detecting means 50 is positioned in a diametrical direction, a peripheral direction and an axial direction by inserting to the opening hole 61 and bringing the lower end surface in the axial direction of the resin table 51 into contact with the mounting plate 24 arranged in the lower side in the axial direction of the first circuit board 60. Thereafter, an electric conduction can be achieved by soldering between the side surface end portion 54a of the conductive pin 54 and a land portion 62 formed at a position brought into contact with the side surface end portion 54a in correspondence to the side surface end portion 54a in the first circuit board 60.

Further, referring to FIG. 10, the structure may be made such that a lower extending portion 54a1 extending to a lower side in the axial direction from an end portion in a diametrical direction of the side surface end portion 54a of the current-carrying pin 54 is provided, and is brought into contact with the first circuit board 60. Even in this case, the land portion 62 is formed around the side surface end portion 54a. Further, an electric conduction between the first circuit board 60 and the current-carrying pin is achieved by putting a solder on the land portion 62.

The description is given above of one aspect of the embodiment in accordance with the present invention, however, the present invention is not limited to the embodiment.

For example, in the present embodiment, the positioning mark 26a and the positioning concave portion 26b corresponding to the lower positioning projection 31b of the insulating resin table 31 are formed in the first circuit board 26, however, the present invention is not limited to this. At least any one of the positioning mark 26a and the positioning concave portion 26b may be formed. Further, the positioning mark 26a in accordance with the present embodiment is printed while simulating an entire periphery of the outer shape of the position detecting structure 30, however, the present invention is not limited to this. Since the positioning mark 26a aims to determine the position in the diametrical direction and the peripheral direction of the position detecting structure 30, the positioning mark 26a may be constituted by a mark which can determine the position in the diametrical direction and the peripheral direction of the position detecting structure 30. For example, the positioning mark 26a may be constituted by a mark formed only by a corner portion in an outer periphery corresponding to a position reference of the position detecting structure 30. Further, the positioning mark 26a may use a conductive pattern formed on the first circuit board 26 together.

What is claimed is:

1. A brushless motor comprising:
a rotation portion being rotatable around a rotation axis and including a turntable and a rotor magnet, said turntable on which a detachable discoid disc is mounted is arranged on an upper surface of said rotation portion and said rotor magnet is circumferentially arranged on a peripheral surface of said rotation portion;
a fixed portion including a stator which radially faces to said rotor magnet, a mounting plate which is arranged in an axially lower side of said stator, and a first circuit board which is arranged on an axially upper surface of said mounting plate; and
a position detecting structure which reads a positional information on a back surface of said discoid disc and is conducted to said first circuit board, wherein:
said position detecting structure includes an insulating resin table;
a second circuit board arranged on an axially upper surface of said insulating resin table, a current-carrying pin penetrating said insulating resin table and electrically conducting said first circuit board and said second circuit board; and
both ends of said current-carrying pin protrudes from said insulating resin table.

2. A brushless motor as set forth in claim 1, wherein one end of said current-carrying pin is fixed to a land portion formed in said first circuit board by a solder and another end of said current-carrying pin is fixed to a land portion formed in said second circuit board by a solder.

3. A brushless motor as set forth in claim 1, wherein:
said current-carrying pin is formed in an approximately L shape;
one end of said current-carrying pin protrudes said axially upper surface of said insulating resin table; and
other end of said current-carrying pin protrudes a side surface of said insulating resin table.

4. A brushless motor as set forth in claim 3, wherein one end of said current-carrying pin is fixed to a land portion formed in said first circuit board and another end of said current-carrying pin is fixed to a land portion formed in said second circuit board by a solder.

5. A brushless motor as set forth in claim 3, wherein a positioning mark simulating at least a part of an outer shape of said position detecting structure is formed at a portion to which said positioning mean of said first circuit board is fixed.

6. A brushless motor as set forth in claim 1, wherein:
at least one lower positioning projection which axially downwardly protrudes from a lower surface of said insulating resin table is formed at an axially lower portion of said insulating resin table; and
a positioning concave portion corresponding to said lower positioning projection is formed on an axially upper surface of said first circuit board.

7. A brushless motor as set forth in claim 6, wherein:
at least one upper positioning projection which axially upwardly protrudes from an upper end surface of said insulating resin table is formed at an axially upper portion of said insulating resin table; and
a positioning concave portion corresponding to said upper positioning projection is formed on an axially lower surface of said second circuit board.

8. A brushless motor as set forth in claim 7, wherein an annular concave portion which is concave from a surface of said insulating resin table is formed around a coupling portion between said upper positioning projection in said insulating resin table and said insulating resin table.

9. A brushless motor as set forth in claim 1, wherein:
at least one upper positioning projection which axially upwardly protrudes from an upper end surface of said insulating resin table is formed at an axially upper portion of said insulating resin table; and
a positioning concave portion corresponding to said upper positioning projection is formed on an axially lower surface of said second circuit board.

10. A brushless motor as set forth in claim 9, wherein:
two or more of said positioning concave portions of said second circuit board are formed in a distanced manner;
two or more of said upper positioning projections which are correspond to said positioning concave portions respectively are provided;
one of said positioning concave portions and one of said upper positioning projection are tightly fitted; and
other of said positioning concave portions and other of upper positioning projections are fitted with a gap maintained therebetween.

11. A brushless motor as set forth in claim 9, wherein an annular concave portion which is concave from a surface of said insulating resin table is formed around a coupling portion between said upper positioning projection in said insulating resin table and said insulating resin table.

12. A brushless motor as set forth in claim 1, wherein a positioning mark simulating at least a part of an outer shape of said position detecting mean is formed at a portion to which said positioning mean of said first circuit board is fixed.

13. A brushless motor as set forth in claim 1, wherein a concave portion which is concave from a surface of said insulating resin table is formed around said current-carrying pin protruding.

14. A brushless motor as set forth in claim 1, wherein:
a recording surface having an information recording region is formed on one surface of said discoid disc; and
a pattern forming portion on which a circumferential pattern information is formed on other surface of said discoid disc.

15. A brushless motor as set forth in claim 14, wherein:
said position detecting structure includes an optical detecting element as said position detecting element; and
said optical element obtains a rotational information by optically detecting said pattern forming portion.

16. A recording disc driving apparatus comprising:
a brushless motor as set forth in claim 1; and
a laser type pickup arranged in an axially lower side of said discoid disc and reading/writing said discoid disc, wherein:
said discoid disc is an optical disc.

17. A brushless motor comprising:
a rotation portion being rotatable around a rotation axis and including a turntable and a rotor magnet, said turntable on which a detachable discoid disc is mounted is arranged on an upper surface of said rotation portion, and said rotor magnet is circumferentially arranged on a peripheral surface of said rotation portion;
a fixed portion including a stator which radially faces to said rotor magnet, a mounting plate which is arranged in an axially lower side of said stator, and a first circuit board which is arranged on an axially upper surface of said mounting plate; and
a position detecting structure fixed to said first circuit board so as to axially face said first circuit board, said position detecting structure is radially outwardly arranged from said rotation portion and optically detects a rotation information provided on said optical disc, wherein:
said position detecting structure includes an insulating resin table, a current-carrying pin penetrating said insulating resin table, a second circuit board having an insertion hole to which said current-carrying pin is inserted and arranged on an axially upper surface of said insulating resin table, and an optical element mounted on an axially upper surface of said second circuit board;
said current-carrying pin is formed in an approximately L shape, one end of which protrudes an axially upper surface of said insulating resin table, and another end of which protrudes a side surface of said insulating resin table; and
one end of said current-carrying pin is fixed to a land portion formed in said first circuit board by a solder and other end of said current-carrying pin is fixed to a land portion of said second circuit board by a solder.

18. A brushless motor as set forth in claim 17, wherein a positioning mark simulating at least a part of an outer shape of said positioning structure is formed at a portion to which said positioning mean of said first circuit board is fixed.
